(19) United States
(12) Patent Application Publication
(10) Pub. No.: US 2026/0229114 A1
(43) Pub. Date: Aug. 6, 2026

(54) Track Matching for Vehicle Localization

(71) Applicant: Nissan North America, Inc., Franklin, TN (US)

(72) Inventors: Liam Pedersen, San Francisco, CA (US); Pratham Oza, San Jose, CA (US); Viju James, Fremont, CA (US); Dhanesh R. Pamnani, Sunnyvale, CA (US)

(21) Appl. No.: 19/043,053

(22) Filed: Jan. 31, 2025

(51) Int. Cl. G08G 1/01; G01S 17/86; G06T 7/20; G06V 20/54

(52) U.S. Cl. CPC G08G 1/0116; G01S 17/86; G06T 7/20; G06V 20/54; G06T 2207/30236; G06T 2207/30242; G06V 2201/07; G06V 2201/08

(57) ABSTRACT

Pose data originating from an ego vehicle and associated with a set of timestamps is obtained. Object detection data from at least one stationary sensor, associated with objects in a tracking region and additional timestamps, is obtained. Based on the pose data, a set of tracks is generated, each track having data containers linked to timestamps. Based on the object detection data, additional track sets are generated with data containers linked to the additional timestamps. A matched track from the first set and an additional matched track from the additional sets are identified based on timestamp comparisons. An ego vehicle object is determined using subsets of both track sets and the matched tracks. This approach may enable robust vehicle localization by fusing data from multiple sources and comparing temporally-aligned tracks.

### TECHNICAL FIELD

This application relates to a track based moving object identification for distributed sensing applications, particularly for vehicle control applications.

### BACKGROUND

Connected vehicles traversing a transportation network can be controlled using a combination of infrastructure sensors associated with the transportation network, sensors on the connected vehicles, and computational resources disposed outside of the vehicles. However, identification of a vehicle being controlled among a number of surrounding objects can be challenging.

### SUMMARY

In one embodiment, a method is provided. In this embodiment, the method includes obtaining pose data originating from an ego vehicle, wherein the pose data is associated with a set of timestamps; obtaining object detection data, originating from at least one stationary sensor, associated with a set of objects within a tracking region, the object detection data associated with at least one additional set of timestamps; generating, based on the pose data, a set of tracks, each track of the set of tracks comprising at least one data container associated with at least one timestamp of the set of timestamps; generating, based on the object detection data, at least one additional set of tracks, each track of the at least one additional set of tracks comprising at least one additional data container associated with at least one additional timestamp of the corresponding additional set of timestamps; matching, based on the set of timestamps and the additional set of timestamps, a matched track of the set of tracks and an additional matched track of the at least one additional set of tracks; and determining, based on a subset of the set of tracks, a subset of the at least one additional set of tracks and the matching of the matched track and the additional matched track, an ego vehicle object of the set of objects.

In another embodiment, a system is provided. In this embodiment, the system includes one or more memories and processing circuitry configured to execute instructions stored in the one or more memories to cause the system to: obtain pose data originating from an ego vehicle, wherein the pose data is associated with a set of timestamps; obtain object detection data, originating from at least one stationary sensor, associated with a set of objects within a tracking region, the object detection data associated with at least one additional set of timestamps; generate, based on the pose data, a set of tracks, each track of the set of tracks comprising at least one data container associated with at least one timestamp of the set of timestamps; generate, based on the object detection data, at least one additional set of tracks, each track of the at least one additional set of tracks comprising at least one additional data container associated with at least one additional timestamp of the corresponding additional set of timestamps; match, based on the set of timestamps and the additional set of timestamps, a matched track of the set of tracks and an additional matched track of the at least one additional set of tracks; and determine, based on a subset of the set of tracks, a subset of the at least one additional set of tracks and the matching of the matched track and the additional matched track, an ego vehicle object of the set of objects.

In yet another embodiment, a non-transitory medium having embodied thereon computer-executable instructions is provided. In this embodiment, when executed by processing circuitry, the instructions cause the processing circuitry to perform operations comprising: obtaining pose data originating from an ego vehicle, wherein the pose data is associated with a set of timestamps; obtaining object detection data, originating from at least one stationary sensor, associated with a set of objects within a tracking region, the object detection data associated with at least one additional set of timestamps; generating, based on the pose data, a set of tracks, each track of the set of tracks comprising at least one data container associated with at least one timestamp of the set of timestamps; generating, based on the object detection data, at least one additional set of tracks, each track of the at least one additional set of tracks comprising at least one additional data container associated with at least one additional timestamp of the corresponding additional set of timestamps; matching, based on the set of timestamps and the additional set of timestamps, a matched track of the set of tracks and an additional matched track of the at least one additional set of tracks; and determining, based on a subset of the set of tracks, a subset of the at least one additional set of tracks and the matching of the matched track and the additional matched track, an ego vehicle object of the set of objects.

These and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. For example, the dimensions of various features may be expanded or reduced for clarity. Further, like reference numbers refer to like elements throughout the drawings unless otherwise noted.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 shows a block diagram of an example of a computing device capable of performing functions described later herein.

FIG. 4 illustrates an example of a controlled roadway region, in accordance with the present disclosure.

FIG. 5 is a block diagram of a system comprising a vehicle identification component in accordance with embodiments of this disclosure.

FIG. 6 is a diagram illustrating an example associated with track matching for vehicle localization, in accordance with the present disclosure.

FIG. 7 is a diagram illustrating another example associated with track matching for vehicle localization, in accordance with the present disclosure.

FIG. 8 is a diagram illustrating another example associated with track matching for vehicle localization, in accordance with the present disclosure.

FIGS. 9A and 9B are diagrams illustrating examples associated with infrastructure sensor handoff in a controlled roadway region, in accordance with the present disclosure.

FIG. 10 is a flow diagram illustrating an example of a technique 1000 associated with track matching for vehicle localization, in accordance with the present disclosure.

### DETAILED DESCRIPTION

A transportation network may incorporate infrastructure sensors, such as light detection and ranging (LiDAR) sensors, strategically placed along roadways, intersections, and/or high-traffic areas. These infrastructure sensors can be configured to collect environmental data, such as positions, speeds, directions of travel, and/or orientations of objects such as vehicles and surrounding obstacles within the sensors' respective fields of view. Such data can be communicated to a cloud-based system, where it can be processed and analyzed to generate insights or instructions relevant to the operation of connected vehicles. For example, the cloud-based system can determine optimal driving patterns, provide control instructions to vehicles, alert vehicles to potential hazards, and/or regulate traffic flow based on real-time conditions gathered by the infrastructure sensors.

In some cases, the connected vehicles may be fully autonomous vehicles. In other cases, the connected vehicles in such examples may not be fully autonomous but may be equipped with communication modules that enable bidirectional communication with the cloud-based system. A connected vehicle may receive driving control instructions, recommendations regarding lane changes, speed adjustments, and/or route modifications based on data captured by LiDAR sensors within the transportation network. Examples of scenarios in which such infrastructure sensors and control systems may be implemented may include controlled roadway regions. The term “controlled roadway region” may include a defined area within which at least a portion of (and, in some cases, a majority of) the traffic on the roadways therein is subject to control by a single entity (e.g., a human operator, a company, a conglomerate of companies, a governmental entity, etc.). One example of a controlled roadway region is an area in which finished vehicles are managed and transported, such as a factory property, test course, or distribution center, among other examples. Another example of a controlled roadway region is a construction zone in which construction vehicles may be controlled via external systems. Yet another example of a controlled roadway region is an airport in which various vehicles such as refueling vehicles, baggage carriers, and/or other vehicles may be controlled via an airport system. In some examples, a controlled roadway region can include any portion of a highway, town, and/or other area in which infrastructure sensors have been installed to support external control of at least one vehicle on the roadways therein.

In the field of vehicle localization and tracking, advanced technologies such as Global Positioning System (GPS) and Light Detection and Ranging (LiDAR) sensors have become important components of modern transportation systems. These technologies enable the precise positioning and monitoring of vehicles within complex environments, particularly in controlled roadway regions where multiple vehicles operate simultaneously. However, the integration and synchronization of data from these diverse sources present technical challenges that may impact the accuracy and reliability of vehicle identification and tracking systems.

One of the technical hurdles in current vehicle localization systems is the inaccuracy of GPS data, especially in urban environments or areas with limited satellite visibility. GPS signals can be affected by various factors such as atmospheric conditions, multipath effects, and signal obstructions, leading to position errors that can range from a few meters to tens of meters. This lack of precision may pose a challenge when attempting to match a specific vehicle's GPS data with object detection data from stationary sensors, such as LiDAR systems, which typically offer higher spatial resolution but lack the ability to directly identify individual vehicles.

Furthermore, the asynchronous nature of data collection between GPS devices and stationary sensors introduces additional complexities in data fusion and interpretation. GPS and LiDAR systems often operate at different update rates and with varying latencies, making it difficult to align temporal data points accurately. This temporal misalignment can lead to errors in object association and tracking, particularly in dynamic environments where vehicles are in constant motion. The challenge is further compounded by the need to process and analyze large volumes of data in real-time, as delayed processing can result in outdated information that is of limited use for immediate decision-making in vehicle control applications.

Another technical issue arises from the need to maintain continuous tracking of vehicles as they move between the coverage areas of different stationary sensors. The handoff process between sensors may need to be seamless to avoid gaps in tracking or misidentification of vehicles. This may require algorithms capable of maintaining object identity across different sensor perspectives and dealing with temporary occlusions or sensor blind spots. Additionally, the system may need to be robust enough to handle scenarios where multiple vehicles with similar characteristics are in close proximity, presenting challenges in distinguishing and correctly identifying the target vehicle among numerous detected objects.

Implementations of this disclosure address problems such as these by obtaining pose data from an ego vehicle and object detection data from stationary sensors, generating tracks based on this data, matching tracks, and determining an ego vehicle object among detected objects. As used herein, the term “pose data” refers to information about a vehicle's position, orientation, and motion, including geographic position, yaw angle, and velocity measurements. For example, pose data may include geolocation data such as, for example, global positioning system (GPS) coordinates, compass heading, and speedometer readings from the ego vehicle. In some implementations, additional pose information such as pitch and roll angles or acceleration data may be incorporated.

The system improves upon existing vehicle localization techniques by combining data from infrastructure-based sensors and on-vehicle systems to achieve more accurate and robust tracking. This technical solution involves time synchronization of asynchronous data streams, multi-dimensional track generation, and probabilistic matching algorithms. The stationary sensors may include LiDAR devices, radar systems, or cameras mounted along roadways or at intersections, providing object detection data for multiple vehicles and obstacles within their field of view.

A component of the system is the generation of “tracks” based on both pose data and object detection data. As used herein, a “track” refers to a time-sequenced collection of data containers, each associated with a specific timestamp and containing relevant state information. For example, a track generated from ego vehicle pose data may include a series of data containers, each holding position, orientation, and velocity information for a particular moment in time. Tracks generated from object detection data similarly capture the observed states of potential vehicle matches over time. In some implementations, additional data fields may be incorporated in the tracks, such as acceleration or object classification information.

The matching process aligns tracks from different data sources based on their timestamps, enabling direct comparison of ego vehicle pose estimates with detected object states. This temporal alignment addresses challenges arising from varying sensor update rates and communication latencies. The system employs a probabilistic matching approach, which may utilize multivariate error calculations such as Mahalanobis distance to quantify the similarity between tracks. In some implementations, matching techniques could include particle filters or multi-hypothesis tracking algorithms to handle ambiguous cases.

Determining the ego vehicle object among detected objects involves analyzing both individual track matches and relative comparisons over time. The system calculates a total confidence value based on a function of error values (comparing matched tracks directly) and relative error values (considering how well a potential match compares to other candidates). This approach allows the system to adapt to changing environments and recover from temporary mismatches or occlusions. In some implementations, confidence calculation methods may incorporate machine learning techniques to weigh different factors based on historical performance data.

The system further enhances its robustness through adaptive tracking region management and multi-sensor fusion. As used herein, a “tracking region” refers to a spatial area around the estimated ego vehicle position within which potential matches are considered. The system can dynamically adjust the size of this region based on the number of detected objects, expanding the search area if too few candidates are found. In multi-sensor scenarios, the system can perform seamless handoffs between different stationary sensors, maintaining continuous tracking as vehicles move through the environment. In some implementations, federated filtering techniques may be incorporated to optimally combine data from multiple, potentially heterogeneous, sensor sources.

In some implementations, the system generates tracks based on both pose data from the ego vehicle and object detection data from stationary sensors. Accordingly, an advantage of the track generation approach may be improved accuracy in vehicle localization by combining data from multiple sources. Additionally, an advantage of the track generation approach may be increased robustness to sensor errors or temporary occlusions, as the system can maintain tracking even if one data source is temporarily unavailable. Furthermore, an advantage of the track generation approach may be its ability to handle asynchronous data streams with different update rates, enabling seamless integration of various sensor types.

In some implementations, the system utilizes a probabilistic matching algorithm to identify the ego vehicle among detected objects. Accordingly, an advantage of the probabilistic matching algorithm may be its ability to handle uncertainty in both pose estimates and object detections. Additionally, an advantage of the probabilistic matching algorithm may be improved performance in complex scenarios with multiple similar objects, as it can consider multiple hypotheses simultaneously. Moreover, an advantage of the probabilistic matching algorithm may be its adaptability to changing environments, as it can adjust confidence levels based on the quality and consistency of matches over time.

In some implementations, the system employs adaptive tracking region management. Accordingly, an advantage of the adaptive tracking region management may be improved computational efficiency by focusing on the most relevant objects near the estimated ego vehicle position. Additionally, an advantage of the adaptive tracking region management may be enhanced scalability, allowing the system to handle varying densities of objects in different environments. Furthermore, an advantage of the adaptive tracking region management may be its ability to dynamically adjust to changes in GPS accuracy or sensor coverage, ensuring consistent performance across diverse operating conditions.

In controlled roadway environments, implementations may include a vehicle logistics autonomy (VLA) system located outside of a vehicle and configured to determine driving operations for controlling the vehicle. The VLA system may generate driving instructions for controlling the vehicle to traverse a transportation network of a controlled roadway region. The ICU may be temporarily installed in the vehicle and may include at least one sensor. In some implementations, the ICU may be permanently installed in the vehicle (e.g., in the case of a fully autonomous vehicle). The VLA system may transmit a control signal to the ICU, where the control signal is indicative of the driving instructions or information from which driving instructions may be derived by the ICU.

Implementations of this disclosure may enable the ICU to receive additional instructions from a tele-operation device to control the vehicle. This capability allows for human intervention when necessary, providing a flexible system that can adapt to unexpected situations or complex scenarios that may arise. The VLA system may also determine an occurrence of an operation issue with the vehicle and communicate an indication of the operation issue to the tele-operation device, facilitating rapid response to potential problems and maintaining efficient operations within the controlled roadway region.

The term “controlled roadway region” may include a defined area within which a majority of the traffic on the roadways therein is subject to control by a single entity (e.g., a human operator, a company, a conglomerate of companies, a governmental entity, etc.). One example of a controlled roadway region is an area in which finished vehicles are managed and transported, such as a factory property, test course, or distribution center, among other examples. Another example of a controlled roadway region may include an airport, in which vehicles may be used to facilitate providing services to aircraft, maintenance, and/or the like. Controlled roadway regions may be implemented in any number of different scenarios, all of which are considered to be within the ambit of the present disclosure.

A controlled roadway region, as defined in this disclosure, can differ significantly from a typical roadway region in a number of aspects. In a controlled roadway region, a single entity may have authority over at least some of the traffic, allowing for a more structured and predictable environment. This level of control can enable the implementation of specialized systems and protocols that may not be feasible in typical roadway regions where traffic is more diverse and less regulated.

One of the primary differences between a controlled roadway region and a typical roadway region is the ability to implement comprehensive sensor networks and infrastructure components throughout the controlled roadway region. These systems may include cameras, LiDAR sensors, and/or other monitoring devices that provide data about vehicle positions, speeds, orientations, and/or environmental conditions. In contrast, typical roadway regions may have limited sensor coverage, relying more heavily on individual vehicle sensors and sporadic traffic monitoring systems.

The controlled nature of the roadway region also may allow for the implementation of standardized communication protocols between connected vehicles and infrastructure. This may include dedicated short-range communication (DSRC) systems or cellular vehicle-to-everything (C-V2X) technologies that enable seamless information exchange. Such comprehensive communication networks are often not feasible in typical roadway regions due to the diverse range of vehicles and the challenges of retrofitting existing infrastructure.

Implementations of the VLA system described herein take advantage of these differences by utilizing the controlled environment to create a more efficient and predictable system for managing vehicles. The VLA system can leverage the comprehensive sensor data and communication networks to maintain an accurate and up-to-date world model of the entire controlled roadway region. This allows for more precise planning and coordination of vehicle movements, reducing the likelihood of conflicts or inefficiencies that might occur in less controlled environments.

Furthermore, short, established routes that vehicles may take within a controlled roadway region can present unique opportunities for optimization. Unlike typical automated vehicles that may need to navigate complex and unpredictable city streets or highways, vehicles in a controlled roadway region may follow predetermined paths between known points of interest, such as assembly lines, testing areas, and distribution centers. This may allow the VLA system to create highly optimized trajectories and schedules, taking into account factors such as production timing, vehicle specifications, and distribution requirements.

In some implementations, the controlled environment may enable the use of removable ICUs in vehicles. These ICUs can be designed specifically for the controlled roadway region, focusing on the limited set of maneuvers and routes required within the facility. This contrasts with the more complex autonomous driving systems needed for typical automated vehicles that must handle a wide range of driving scenarios and environments. The removable ICUs may be more cost-effective and easier to install and remove, facilitating the efficient movement of vehicles through logistics processes.

According to some implementations, a VLA system (which may be implemented as one or more physical machines and/or virtual machines) accesses infrastructure data from sensors of an infrastructure associated with a roadway portion of the controlled roadway region. The sensors may include any number of different types of roadway sensors. The infrastructure data may include a position of a vehicle, a velocity of a vehicle, and/or a following distance of another vehicle in relation to the vehicle, among other examples. The VLA system may store the infrastructure data in a world model. The VLA system may generate, using the world model, a data structure representing predicted future velocities on the roadway portion by position and time by applying a traffic flow model to the world model. The traffic flow model may be, for example, an artificial intelligence model trained using at least one of supervised learning, unsupervised learning, reinforcement learning, online learning, or the like.

The VLA system may transmit a control signal to the removable ICU provided in a vehicle for controlling operation of the vehicle based on the generated data structure. In some implementations, the ICU may be connected to a controller of the vehicle. The controller may include a computing device on board the vehicle. In an example, the control signal can be a specific control parameter (e.g., specific control parameter values) that may be used to control a component of the powertrain of the vehicle. In another example, the control signal can be or include data that the ICU can use to obtain the control parameter. For example, the ICU may be or include a machine leaning model that uses at least portions of the control signal to obtain (e.g., infer, output) the control parameter that can be used to control the component of the powertrain of the vehicle. The control parameter can depend on the capabilities of the ICU and/or of the vehicle.

As used herein, the term “model” may include, among other things, at least one of a classic planning model, an artificial intelligence (AI) model, or a machine-learning (ML) model that uses supervised learning, unsupervised learning, reinforcement learning, or the like. A model may be based on data that was generated in the past and may be used to predict future data. For example, a long-term shared world model of a roadway portion may store data about average velocities and congestion (e.g., number of vehicles per unit distance) of the roadway portion in the past (e.g., at multiple times in the past three years) and be used to predict the average velocities and the congestion of the roadway portion in the future (e.g., next Monday morning at 9 am). The prediction may be made, for example, using AI or ML techniques or other mathematical modeling techniques.

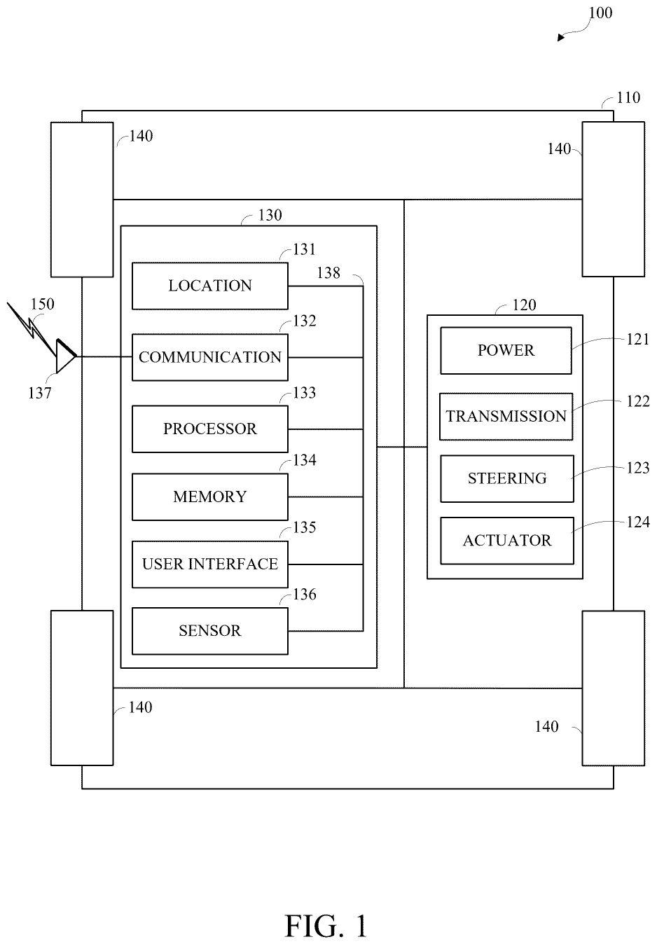

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. The communication interface 137 may be in communication with a satellite. Although FIG. 1 shows a single communication interface 137, a vehicle may include any number of communication interfaces.

The communication unit 132 may be configured to transmit and/or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, satellite signals, or a combination thereof. For example, the communication unit 132 may be configured to transmit and/or receive telecommunication protocols such as 4G, 5G, Long Term Evolution (LTE), and/or 6G, among other examples. The communication unit 132 may be configured to communicate via sidelink networks using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols, among other examples. Although FIG. 1 shows a single communication unit 132 and a single communication interface 137, any number of communication units and any number of communication interfaces may be used. The communication unit 132 may include a dedicated short-range communications (DSRC) unit, an on-board unit (OBU), or a combination thereof.

The location unit 131 may determine geolocation information, such as longitude, latitude, elevation, direction of travel, or velocity, of the vehicle 100. For example, the location unit may include or be in communication with, a global positioning system (GPS) unit (which may be referred to as a “GPS receiver” or a “GPS device”), a global navigation satellite system (GNSS), a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, LiDAR, GPS, GNSS, internal measurement unit (IMU), cameras, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

Although not shown separately, the vehicle 100 may include a trajectory follower. For example, the controller 130 may include the trajectory follower. The trajectory controller may be operable to obtain information describing a current state of the vehicle 100 and a route planned for the vehicle 100, and, based on this information, to determine and optimize a trajectory for the vehicle 100. In some embodiments, the trajectory follower may output signals operable to control the vehicle 100 such that the vehicle 100 follows the trajectory that is determined by the trajectory follower. In some embodiments, the trajectory follower may follow a trajectory that is determined by an external system (e.g., a VLA system). A trajectory may include an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

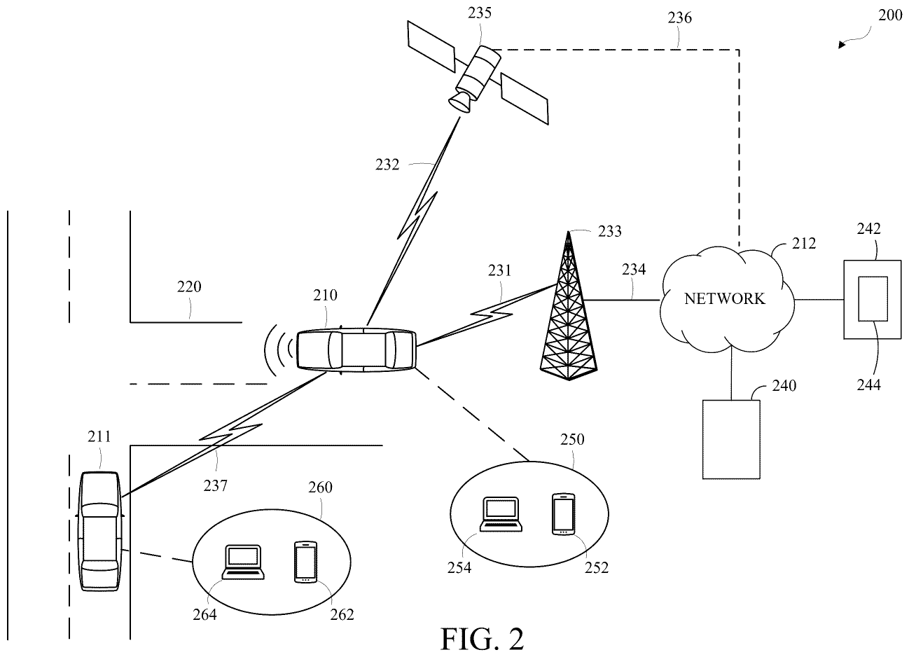

FIG. 2 is a diagram of an example of a portion of a vehicle transportation and communication system 200 in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211, one or more communication devices 240, and/or an operations center 242. For example, a vehicle 210/211 may receive information, such as information representing the vehicle transportation network 220, from a communication device 240 and/or the operations center 242 via the network 230.

The operations center 242 may include a controller apparatus 244, which may include some or all of the features of the controller 130 shown in FIG. 1. In some implementations, the operations center 242 and/or the controller apparatus 244 may be, be similar to, include, or be included in a VLA system. The controller apparatus 244 may be configured to monitor and coordinate the movement of vehicles, including connected vehicles and/or autonomous vehicles. The controller apparatus 244 may monitor the state or condition of vehicles, such as the vehicle 210, vehicle 211, and/or any number of external objects. The controller apparatus 244 may be configured to receive vehicle data and infrastructure data including vehicle velocity, vehicle location, vehicle orientation, vehicle operational state, vehicle destination, vehicle route, vehicle sensor data, external object velocity, external object location, external object orientation, external object operational state, external object destination, external object route, and/or external object sensor data, among other examples.

Further, the controller apparatus 244 may establish remote control over one or more vehicles, such as the vehicle 210, the vehicle 211, or external objects. In this way, the controller apparatus 244 may be used to teleoperate the vehicles or external objects from a remote location. The controller apparatus 244 may exchange (send or receive) state data with vehicles, external objects, and/or a computing device via a wireless communication link, such as the wireless communication link 231, or a wired communication link, such as the wired communication link 234. The operations center 242 and/or the controller apparatus 244 may include one or more server computing devices, which may exchange (send or receive) state signal data with one or more vehicles or computing devices).

In some embodiments, a vehicle 210/211 may communicate via a wired communication link (not shown), a wireless communication link 231/232/237, or a combination of any number of wired or wireless communication links. For example, as shown, a vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, an RF link, or any link capable of providing for electronic communication.

A vehicle 210/211 may communicate with another vehicle 210/2110. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, velocity information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a central unit (CU), a distributed unit (DU), a radio unit (RU), an NR network node, a 6G network node, a transmission reception point (TRP), a mobility element of a network, a core network node, a network element, a network equipment, a wireless router, a wired router, a hub, a relay, a switch, or any similar wired or wireless device. Although shown as a single unit in FIG. 2, an access point may include any number of interconnected elements. An access point may be stationary or mobile.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide voice, data, or any other type of electronic communication. For example, the electronic communication network 230 may include a local area network (LAN), a wide area network (WAN), a virtual private network (VPN), a mobile or cellular telephone network, the Internet, an Internet of Things (IoT) network, or any other electronic communication system. The electronic communication network 230 may use a communication protocol, such as transmission control protocol (TCP), user datagram protocol (UDP), internet protocol (IP), real-time transport protocol (RTP), HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a velocity sensor, a wheel velocity sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, one communication device 240, one operations center 242, and one controller apparatus 244, any number of vehicles, networks, computing devices, communication networks, operations centers, and/or controller apparatuses may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210/211 may be associated with an entity 250/260, such as a driver, operator, or owner of the vehicle. In some embodiments, an entity 250/260 associated with a vehicle 210/211 may be associated with one or more personal electronic devices 252/254/262/264, such as a smartphone 252/262 or a computer 254/264. In some embodiments, a personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network 220, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network 220 as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

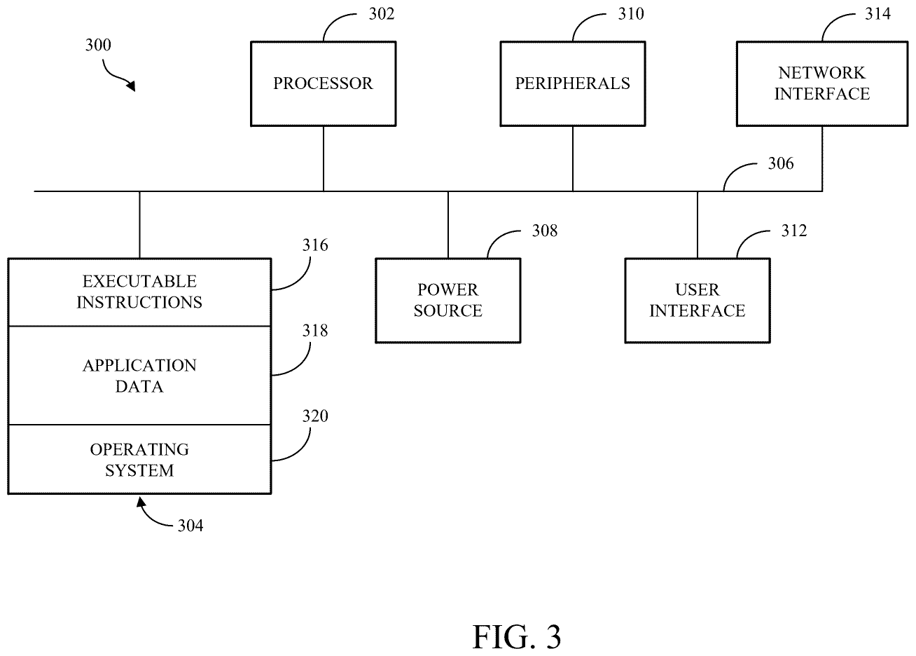

FIG. 3 shows a block diagram of an example of a computing device 300 capable of performing functions described herein. The computing device 300 may be, be similar to, include, or be included in, an apparatus for performing one or more methods, processes, algorithms, operations, tasks, and/or techniques, as described herein. The computing device 300 may be, be similar to, include, or be included in, an ICU, a VLA system, a fleet management device, a tele-operation device, a sensor, a communication device, a vehicle controller (e.g., the controller 130 shown in FIG. 1) and/or a vehicle computer, among other examples. The computing device 300 includes components or units, such as a processor 302, a memory 304, a bus 306, a power source 308, peripherals 310, a user interface 312, a network interface 314, other suitable components, or a combination thereof. One or more of the memory 304, the power source 308, the peripherals 310, the user interface 312, or the network interface 314 can communicate with the processor 302 via the bus 306.

The processor 302 may be a central processing unit, such as a microprocessor, and may include single or multiple processors having single or multiple processing cores. The processor 302 can include another type of device, or multiple devices, configured for manipulating or processing information. For example, the processor 302 can include multiple processors interconnected in one or more manners, including hardwired or networked. The operations of the processor 302 can be distributed across multiple devices or units that can be coupled directly or across a local area or other suitable type of network. The processor 302 can include a cache, or cache memory, for local storage of operating data or instructions.

The memory 304 includes one or more memory components, which may each be volatile memory or non-volatile memory. For example, the volatile memory can be random access memory (RAM) (e.g., a DRAM module, such as DDR SDRAM). In another example, the non-volatile memory of the memory 304 can be a disk drive, a solid state drive, flash memory, or phase-change memory. In some implementations, the memory 304 can be distributed across multiple devices. For example, the memory 304 can include network-based memory or memory in multiple clients or servers performing the operations of those multiple devices.

The memory 304 can include data for immediate access by the processor 302. For example, the memory 304 can include executable instructions 316, application data 318, and an operating system 320. The executable instructions 316 can include one or more application programs, which can be loaded or copied, in whole or in part, from non-volatile memory to volatile memory to be executed by the processor 302. For example, the executable instructions 316 can include instructions for performing techniques of this disclosure. In some implementations, the application data 318 can include functional programs, such as a computational programs, analytical programs, database programs, and so on. The operating system 320 can be, for example, Microsoft Windows®, Mac OS X®, or Linux®; an operating system for a mobile device, such as a smartphone or tablet device; or an operating system for a non-mobile device, such as a mainframe computer.

The power source 308 provides power to the computing device 300. For example, the power source 308 can be an interface to an external power distribution system. In another example, the power source 308 can be a battery, such as where the computing device 300 is a mobile device or is otherwise configured to operate independently of an external power distribution system. In some implementations, the computing device 300 may include or otherwise use multiple power sources. In some such implementations, the power source 308 can be a backup battery.

The peripherals 310 may include one or more sensors, detectors, or other devices configured for monitoring the computing device 300 or the environment around the computing device 300. For example, the peripherals 310 can include a geolocation component, such as a GPS location unit. In another example, the peripherals can include a temperature sensor for measuring temperatures of components of the computing device 300, such as the processor 302. In some implementations, the computing device 300 can omit the peripherals 310.

The user interface 312 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 314 provides a connection or link to a network (e.g., the electronic communication network 230 shown in FIG. 2). The network interface 314 can be a wired network interface or a wireless network interface. The computing device 300 can communicate with other devices via the network interface 314 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 300 can communicate with a database server.

The network interface 314 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a vehicle, a system, or a device as taking an action (such as performing, determining, initiating, receiving, calculating, deciding, etc.) are to be understood that some appropriate component of the vehicle, system, or device as taking the action. Such components may refer to hardware and/or software configured to take the action.

An apparatus, computing device (e.g., the computing device 300), system, and/or vehicle, described herein may include one or more chips, system-on-chips (SoCs), chipsets, packages, and/or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include a memory system in the form of one or more memory devices, memory blocks, memory elements or other discrete gate or transistor logic or circuitry, each of which may include tangible storage media such as RAM or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The apparatus may include or may be included in a housing that houses components associated with the apparatus including the processing system.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 3, such as a single processor or a combination of multiple different processors. Reference to “one or more processors” should be understood to refer to any one or more of the processors described in connection with FIG. 3.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 3. For example, an operation described as being performed by one or more memories can be performed by the same subset of the one or more memories or different subsets of the one or more memories.

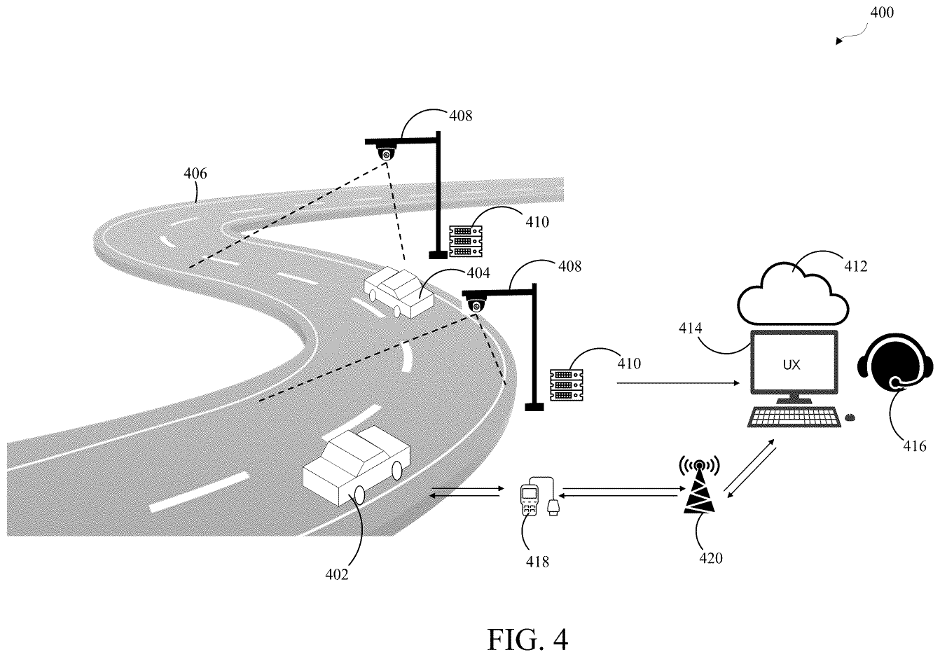

FIG. 4 is a schematic diagram showing an operating environment 400 within which aspects of the system and apparatuses described herein may be implemented. The operating environment 400 may be, be similar to, include, or be included in, a controlled roadway region where vehicles 402 and 404 are managed and transported autonomously. The operating environment 400 may be, be similar to, include, or be included in, the vehicle transportation and communication system 200 shown in FIG. 2.

The operating environment 400 includes a roadway 406. Along the roadway 406, multiple infrastructure components 408 are positioned. The infrastructure components 408 may include various sensors, cameras, and communication devices that continually monitor the environment and the vehicles 402 and 404. For example, the infrastructure components 408 may incorporate LiDAR sensors or radar systems to provide detailed environmental data.

The infrastructure components 408 may be implemented in various ways. In some implementations, the infrastructure components 408 may be affixed to and/or integrated into existing roadside equipment, such as street lights, traffic signals, or road signs. This approach may leverage pre-existing infrastructure, potentially reducing installation costs and minimizing additional visual clutter in the environment. For example, cameras or sensors may be fitted to street light poles, providing elevated vantage points for monitoring traffic flow and vehicle movements. In some implementations, the infrastructure components 408 may be standalone devices specifically designed for use with the FVLA system. These purpose-built units may be optimized for the particular requirements of the controlled roadway region, potentially offering enhanced performance or specialized capabilities. In some implementations, a combination of retrofitted existing equipment and new standalone devices may be used to create a comprehensive sensor network that covers the controlled roadway region.

The data collected by the infrastructure components 408 is fed into a perception system 410. The perception system 410 may include hardware, software, or a combination of hardware and software configured to obtain raw data from the infrastructure components 408 and process the raw data to provide sensor data, sometimes referred to as “perception data.” The perception system 410 may use advanced algorithms to detect and track vehicles, identify potential obstacles, and monitor traffic flow within the controlled roadway region.

The operating environment 400 includes a VLA system 412. The VLA system 412 may be responsible for determining driving operations for controlling the finished vehicles. The VLA system 412 receives processed data from the perception system 410 and uses this information to generate driving instructions for each vehicle in the controlled roadway region.

The operating environment 400 may include a user interface 414 communicatively coupled to the FVLA system 412. The user interface 414 may allow an operator 416 (e.g., a fleet operator) to monitor the entire system, view the status of individual vehicles, and intervene if necessary. In some implementations, the user interface 414 may serve as a tele-operation device enabling the operator 416 to provide additional instructions or take control of a vehicle in case of an operational issue.

Each finished vehicle 402 and 404 is equipped with an ICU 418. The ICUs 418 receive control signals from the FVLA system 412 and execute the driving instructions, controlling the vehicles' movements within the operating environment 400.

Communication between the FVLA system 412 and the ICUs 418 in the vehicles is facilitated by an access point 420. This access point 420 may use wireless technology to transmit control signals and receive status updates from the vehicles, ensuring constant connectivity throughout the controlled roadway region. The wireless technology may include, for example, cellular technology.

In some implementations, the operating environment 400 could be adapted to handle various scenarios within the controlled roadway region. For instance, the FVLA system 412 may manage the movement of finished vehicles from a factory to a test course. The VLA system 412 could generate specific driving instructions for navigating the test course, while the infrastructure components 408 monitor the vehicle's performance during testing. In some implementations, the operating environment 400 may facilitate the efficient transfer of vehicles to the distribution hubs. The FVLA system 412 could coordinate the movement of multiple vehicles simultaneously, optimizing routes to a railway distribution hub or a trucking distribution hub based on real-time conditions and scheduling requirements.

Any one or more of the infrastructure components 408, the perception system 410, the FVLA system 412, the user interface 414, the access point 420, and/or the ICU 418, may be, be similar to, include, or be included in, the computing device 300 shown in FIG. 3. Similarly, the vehicle 402 and/or the vehicle 404 may be, be similar to, include, or be included in, the vehicle 100 shown in FIG. 1.

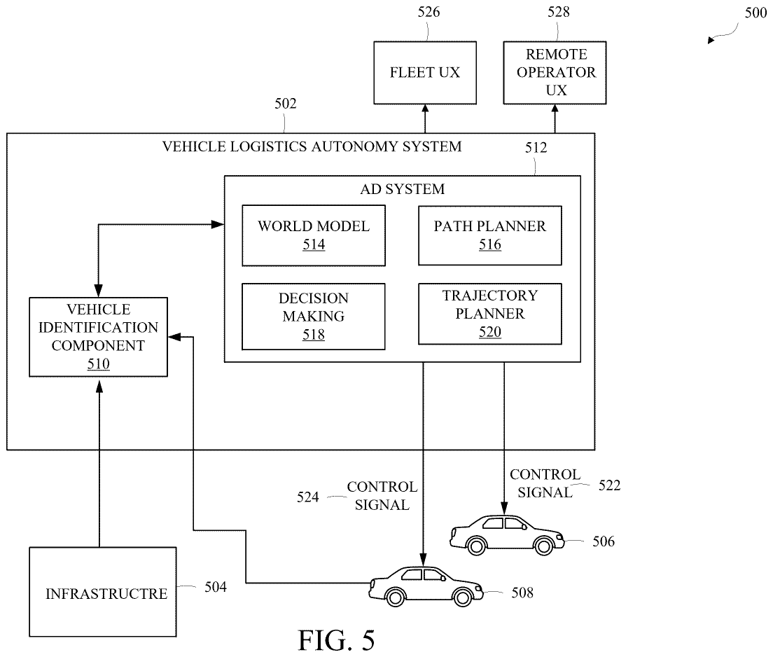

FIG. 5 is a diagram illustrating another example 500 associated with controlling a vehicle in a controlled roadway region, in accordance with the present disclosure. As shown in FIG. 5, the example 500 includes a VLA system 502, which may be located outside of finished vehicles and configured to determine driving operations for controlling the finished vehicles. The VLA system 502 interacts with infrastructure 504 and multiple vehicles, represented by vehicle 506 and vehicle 508. The infrastructure 504 may include various sensors and communication devices positioned throughout the controlled roadway region, similar to the infrastructure components 408 shown in FIG. 4.

As shown in FIG. 5, the VLA system 502 includes a vehicle identification component 510, which receives and processes data from the infrastructure 504 and the vehicles 506, 508. The vehicle identification component 510 may perform track matching operations, as described herein, to facilitate identification of an ego vehicle among a number of detected objects. The vehicle identification component 510 may utilize algorithms to filter, align, and integrate data from various sensors, ensuring that the system has the most accurate and up-to-date information for decision-making.

In some implementations, the vehicle identification component 510 may employ a track matching technique to identify an ego vehicle among a set of objects detected by stationary sensors in a controlled roadway region. This technique may involve obtaining pose data from the ego vehicle, obtaining object detection data from stationary sensors, generating tracks based on the data, matching tracks, and determining the ego vehicle object among the detected objects.

The track matching process may begin with obtaining pose data originating from an ego vehicle, wherein the pose data is associated with a set of timestamps. In some implementations, the pose data may comprise a set of geographic positions, a set of orientation measurements and a set of velocity measurements, each geographic position corresponding to an orientation measurement of the set of orientation measurements, a velocity measurement of the set of velocity measurements, and a timestamp of the set of timestamps. The pose data may be obtained from various sources, such as a global positioning system (GPS) device of the ego vehicle.

Concurrently, the vehicle identification component 510 may obtain object detection data originating from at least one stationary sensor, associated with a set of objects within a tracking region. The object detection data may be associated with at least one additional set of timestamps. In some implementations, the at least one stationary sensor may include a light detection and ranging (LiDAR) device. The object detection data may include at least one additional set of orientation measurements corresponding to the at least one additional set of timestamps and at least one additional set of velocity measurements corresponding to the at least one additional set of timestamps.

Based on the pose data, the vehicle identification component 510 may generate a set of tracks, where each track of the set of tracks includes at least one data container associated with at least one timestamp of the set of timestamps. In some implementations, each data container of the set of tracks may include a geographic position of the set of geographic positions, an orientation measurement of the set of orientation measurements, and a velocity measurement of the set of velocity measurements. The set of tracks may include a first track associated with a first timestamp of the set of timestamps, including a first data container, and a second track associated with a second timestamp of the set of timestamps, including the first data container and a second data container.

Similarly, based on the object detection data, the vehicle identification component 510 may generate at least one additional set of tracks. Each track of the at least one additional set of tracks may include at least one additional data container associated with at least one additional timestamp of the corresponding additional set of timestamps. In some implementations, each data container of the at least one additional data container may include an additional orientation measurement of the additional set of orientation measurements, and an additional velocity measurement of the at least one additional velocity measurements.

The vehicle identification component 510 may then perform matching based on the set of timestamps and the additional set of timestamps, identifying a matched track of the set of tracks and an additional matched track of the at least one additional set of tracks. In some implementations, the matched track may include the second track generated from the pose data, while the additional matched track may include a first additional track of the at least one additional set of tracks generated from the object detection data.

To determine the ego vehicle object from the set of objects, the vehicle identification component 510 may use a subset of the set of tracks, a subset of the at least one additional set of tracks, and the matching of the matched track and the additional matched track. This determination may involve calculating a matching error value based on a comparison of the matched track and the additional matched track. In some implementations, the matching error value may include a Mahalanobis distance value.

The Mahalanobis distance function may be used as a measure of similarity between two sets of data points in a multidimensional space. In the context of track matching for vehicle localization, the Mahalanobis distance may provide a way to quantify the difference between the predicted state of a vehicle (based on pose data) and the observed state (based on object detection data), while accounting for the uncertainties in these measurements. In some implementations, the Mahalanobis distance may be preferred over Euclidean distance because it takes into account the correlations of the data set and is scale-invariant. This means it may be particularly useful when dealing with data that has different units or scales, such as position (in meters) and orientation (in radians).

The vehicle identification component may use the Mahalanobis distance to compare tracks from different data sources. A smaller Mahalanobis distance may indicate a closer match between the predicted and observed states, helping to identify the most likely correspondence between the ego vehicle and detected objects.

The vehicle identification component 510 may also consider the quantity of matched tracks when determining the ego vehicle object. In some implementations, the ego vehicle object may be determined based on the quantity of matched tracks satisfying a quantity threshold. This approach can help ensure a higher level of confidence in the identification of the ego vehicle.

To manage computational resources and maintain relevance of the data, the vehicle identification component 510 may implement track management techniques. In some implementations, the vehicle identification component 510 may determine that a quantity of tracks of the set of tracks satisfies a quantity threshold, and based on this determination, delete a first track of the set of tracks. This process helps maintain a manageable number of tracks while focusing on the most recent and relevant data.

The vehicle identification component 510 may also dynamically adjust the tracking region based on the number of objects detected. In some implementations, if the vehicle identification component 510 determines that a count of objects in the set of objects is less than or equal to a first object threshold, it may obtain additional object detection data originating from at least one stationary sensor, associated with an additional set of objects within an additional tracking region. The ego vehicle object may then be determined based on both the original set of objects and the additional set of objects.

In some implementations, the vehicle identification component 510 may start with a larger tracking region and narrow it down based on object density. For example, the vehicle identification component 510 may obtain additional object detection data associated with an additional set of objects within an additional tracking region, where the additional tracking region has a size larger than the initial tracking region. If the vehicle identification component 510 determines that a count of objects in the additional set of objects is greater than an object threshold, it may establish a smaller tracking region based on this determination.

The determination of the ego vehicle object may be based on various probabilistic and confidence measures. In some implementations, the ego vehicle object may be determined based on a multivariate probability value associated with a comparison between the matched track and the additional matched track satisfying a probability threshold. In some implementations, the determination may be based on a total confidence value, which is derived from a function of a set of error values and a set of relative error values. These approaches allow the vehicle identification component 510 to account for uncertainties and variations in the data while making a robust identification of the ego vehicle.

Connected to the vehicle identification component 510 is an AD system 512, which is responsible for generating driving instructions for controlling the vehicles to traverse the transportation network of the controlled roadway region. The AD system 512 may include several sub-components that work in concert to achieve this goal.

The world model 514 may maintain a real-time representation of the controlled roadway region, including the positions and states of all vehicles, road conditions, and any potential obstacles or hazards. This world model 514 may serves as the foundation for decision-making processes within the system 512.

In some implementations, the world model 514 receives sensor data, such as from the infrastructure 504 and/or the vehicle identification component 510, and determines (e.g., converts to, detects, etc.) objects from the sensor data. That is, the world model 514 determines hazard objects (e.g., road users) from the received sensor data. For example, the world model 514 can convert a point cloud received from a LIDAR sensor into an object, such as a hazard object. Sensor data from several sensors can be fused together to identify the objects. Examples of objects include a non-motorized vehicle (e.g., a bicycle), a pedestrian or animal, a motorized vehicle, etc.

The world model 514 can receive sensor information that allows the world model 514 to calculate and maintain additional information for at least some of the detected objects. For example, the world model 514 can maintain a state for at least some of the determined objects. The state for an object can include zero or more of a velocity, a pose, a geometry (such as width, height, and depth), a classification (e.g., bicycle, large truck, pedestrian, road sign, etc.), and a location. As such, the state of an object includes discrete state information (e.g., classification) and continuous state information (e.g., pose and velocity).

The world model 514 tracks objects, maintains lists of hypotheses for at least some of the dynamic objects (e.g., an object A might be going straight, turning right, or turning left), creates and maintains predicted trajectories for each hypothesis, and maintains likelihood estimates of each hypothesis (e.g., object A is going straight with probability 90% considering the object pose/velocity and the trajectory poses/velocities). In an example, the world model 514 uses an instance of the trajectory planner 520 to generate the predicted trajectories for each object hypothesis for at least some of the dynamic objects. For example, an instance of the trajectory planner 520 can be used to generate predicted trajectories for vehicles, bicycles, and pedestrians. In another example, an instance of a trajectory planner 520, such as the trajectory planner 520 described below, can be used to generate predicted trajectories for vehicles and bicycles, and a different method can be used to generate predicted trajectories for pedestrians. The objects maintained by the world model 514 can include hazard objects, which can include static objects, dynamic objects, or both.

Working in conjunction with the world model 514 is the path planner 516. The path planner 516 generates potential paths for each vehicle based on their current positions and intended destinations. The path planner 516 may consider factors such as road layout, traffic conditions, and vehicle capabilities when determining optimal routes. In some implementations, the path planner 516 determines a road-level plan. For example, given a starting location and a destination location, the path planner 516 determines a route from the starting location to the destination location. The path planner 516 can determine the list of roads (i.e., the road-level plan) to be followed by the vehicle to navigate from the starting location to the destination location.

The road-level plan determined by path planner 516 and the objects (and corresponding state information) maintained by the world model 514 can be used by the decision making component 518 to determine discrete-level decisions along the road-level plan. Examples of decisions included in the discrete-level decisions may include: stop at the next intersection, move forward slowly, accelerate to a certain speed limit, merge into the next lane, etc. For example, the decision making component 518 may evaluate the paths generated by the path planner 516 and select the most appropriate course of action for each vehicle. The decision making component 518 may consider various factors such as safety, efficiency, and adherence to traffic rules when making decisions. In some implementations, the decision making component 518 may utilize machine learning algorithms to improve its decision-making capabilities over time.

Once a decision has been made, the trajectory planner 520 generates detailed trajectories for each vehicle. These trajectories specify the exact path, speed, and maneuvers that a vehicle should follow to execute the chosen path safely and efficiently. For example, the trajectory planner 520 can receive the discrete-level decisions, the objects (and corresponding state information) maintained by the world model 514, and the predicted trajectories and likelihoods of the external objects from the world model 514. The trajectory planner 520 can use at least some of the received information to determine a detailed-planned trajectory, also referred to herein as a proactive trajectory, for the vehicle.

For example, the trajectory planner 520 determines a next-few-seconds trajectory. As such, and in an example where the next few seconds are the next 6 seconds (i.e., a look-ahead time of 6 seconds), the trajectory planner 520 determines a trajectory and locations for the vehicle in the next 6 seconds. For example, the trajectory planner 520 may determine (e.g., predict, calculate, etc.) the expected locations of the vehicle at several time intervals (e.g., every one-quarter of a second, or some other time intervals).

In some implementations, the AD system 512 and/or the ICU installed in a vehicle may include a reactive trajectory control component. For example, the reactive trajectory control component may be a software module of the AD system or may be, be similar to, include, or be included in, a trajectory follower. The reactive trajectory control component can handle situations that the vehicle may encounter but may not be handled by the trajectory planner 520. Such situations include situations where the proactive trajectory of the trajectory planner 520 was based on misclassification of objects and/or unanticipated situations that rarely occur. For example, the reactive trajectory control can modify the proactive trajectory in response to determining that a static object to the left of the vehicle is misclassified. The object may have been classified as a large truck; however, a new classification determines that it is a static road barrier wall. In another example, the reactive trajectory control can modify the proactive trajectory in response to a sudden tire blowout of the vehicle. Other examples of unanticipated situations include another vehicle swerving suddenly (e.g., due to late decision to get to highway off-ramp or tire blowout) into the lane of the vehicle and a pedestrian or other object emerging suddenly from behind an occlusion.

In some implementations, a predictive algorithm of the trajectory planner 520 may be configured to produce plans at 10 hz; on the other hand, the reactive trajectory control may be configured to produce plans at 100 hz.

The VLA system 502 communicates with the vehicles 506, 508 through control signals 522, 524 respectively. These control signals may be transmitted to permanent or removable ICUs installed in the vehicles. The control signals 522, 524 are indicative of the driving instructions generated by the AD system 512 and may cause the ICUs to control the vehicles to traverse the transportation network of the controlled roadway region.

In some implementations, the example 500 may include a fleet UX 526, which provides a user interface for managing and monitoring multiple vehicles simultaneously. This interface may allow operators to view the status and location of all vehicles in the system, track their progress, and identify any potential issues or bottlenecks in the logistics process.

Additionally, the example 500 includes a remote operator UX 528, which may serve as a tele-operation device. This interface allows human operators to remotely monitor and control individual vehicles when necessary. In some cases, the system may determine an occurrence of an operation issue with a vehicle and communicate an indication of the operation issue to the remote operator UX 528. The operator can then use this interface to send additional instructions to control the vehicle, ensuring safe and efficient resolution of any issues that may arise.

In some implementations, the VLA system 502 may incorporate cloud-based L4 AD software, enabling advanced decision-making capabilities and reducing the need for human intervention in most scenarios. The system may also utilize edge computing nodes near the controlled roadway region to process data from the infrastructure 504 and vehicles 506, 508 more quickly, reducing latency and improving real-time responsiveness. In some implementations, the example 500 may be further enhanced by incorporating V2V communication capabilities, allowing vehicles to share information directly with each other. This could improve collision avoidance and enable more efficient traffic flow within the controlled roadway region. For example, if vehicle 506 detects an obstacle, it could immediately communicate this information to vehicle 508 and the VLA system 502, allowing for rapid adjustments to trajectories and decision-making.

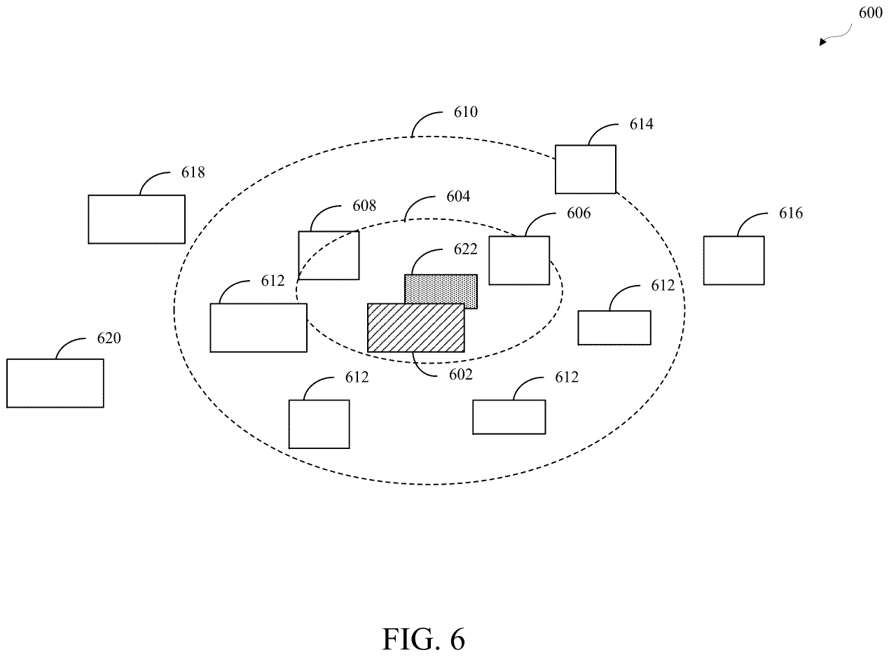

FIG. 6 is a diagram illustrating an example 600 associated with track matching for vehicle localization, in accordance with the present disclosure. As shown, the example 600 includes an ego vehicle 602 represented by a shaded rectangular shape, surrounded by multiple objects depicted as rectangular boxes within a tracking region 604. The tracking region 604 is shown as a dashed oval boundary encompassing the ego vehicle 602 and nearby objects.

In some implementations, the tracking region 604 may be dynamically adjusted based on the number of objects detected within it. For example, if the number of objects is less than a threshold number (e.g., 10 objects), the system may expand the tracking region 604 (as shown, e.g., by the tracking region 610) to include more objects. This dynamic adjustment helps ensure that a sufficient number of potential matches are considered for the ego vehicle localization process.

Within the tracking region 604, several objects are visible, including object 606 and object 608 positioned near the ego vehicle 602. These objects represent potential matches that will be evaluated during the track matching process. The system may filter out objects outside of the tracking region 604, focusing computational resources on the most relevant candidates.

In some implementations, the system may create tracks for each object within the tracking region 604. A track, as used in this disclosure, refers to a time-sequenced collection of data containers, each associated with a specific timestamp and containing relevant state information. For the ego vehicle 602, the system may generate tracks based on pose data received from the vehicle, which may include GPS coordinates, orientation measurements, and velocity measurements.

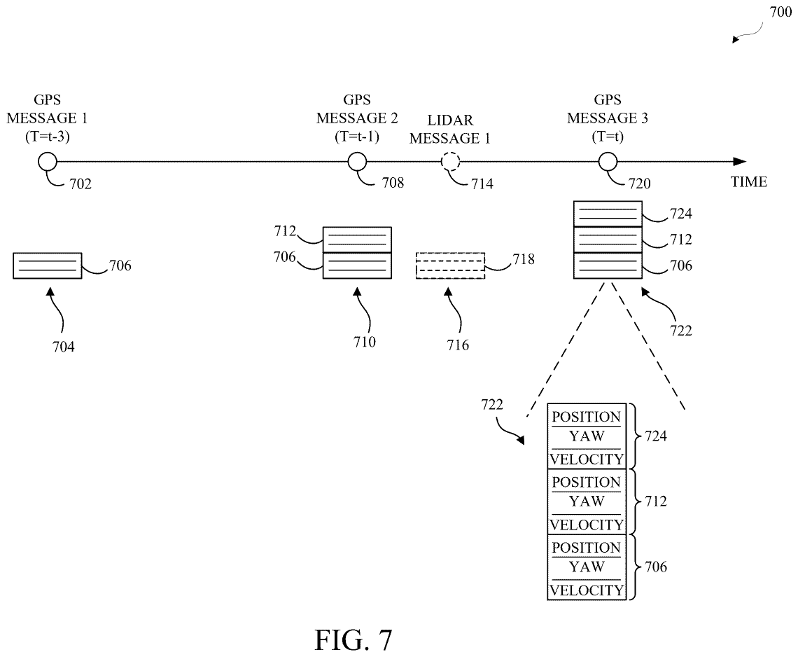

FIG. 7 is a diagram illustrating another example 700 associated with track matching for vehicle localization, in accordance with the present disclosure. This figure demonstrates the temporal sequence of data processing and track generation for both GPS and LiDAR data sources.

As shown in FIG. 7, the process begins with a first GPS message 702 received at time T=t−3. This message is used to create a first GPS track 704, which includes a first GPS track container 706 storing position and velocity data. Subsequently, a second GPS message 708 arrives at T=t−1, leading to the creation of a second GPS track 710 with its corresponding track container 712.

In some implementations, the system may employ a time synchronization method to align GPS and LiDAR data. For example, when a first LiDAR message 714 is received, the system may match its timestamp to the closest GPS message timestamp within a predefined threshold (e.g., 10\hat{ }−3 seconds). This ensures that the data used for processing corresponds to approximately the same point in time, even if it is not the most recent data available.

The first LiDAR message 714 triggers the creation of a first LiDAR track 716 with its associated track container 718. As more data is received, the tracks continue to grow. A third GPS message 720 leads to the creation of a third GPS track 722, which now includes multiple data containers (724, 712, 706) storing position, yaw, and velocity information across different timestamps.

In some implementations, the system may maintain a limited number of recent tracks (e.g., 5 tracks) to balance between historical context and computational efficiency. As new tracks are added, older tracks may be deleted to maintain this limit.

Although the example 700 illustrates a scenario in which a GPS message is received first and more frequently than LiDAR messages, other scenarios are possible. For example, in some implementations, a LiDAR message may be received first and/or LiDAR messages may be received more frequently than GPS messages. In such implementations, the process described above may be modified accordingly. For example, when the first GPS message is received, the system may match its timestamp to the closest LiDAR message timestamp within a predefined threshold. Other scenarios may involve other types of geolocation devices (e.g., a GNSS device, a WAAS NMEA unit, etc.) or other types of stationary sensors (e.g., cameras, radar sensors, etc.). All of the above scenarios or combinations of scenarios are considered to be within the ambit of the present disclosure.

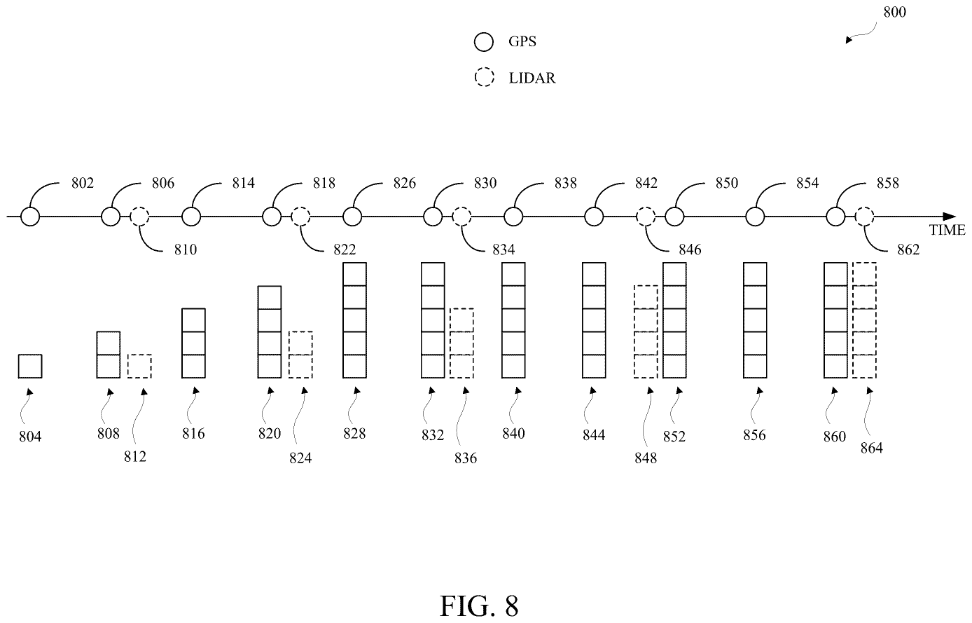

FIG. 8 provides a more detailed view of the track matching process, illustrating an example 800 that shows the evolution of GPS and LiDAR tracks over time. The diagram flows vertically from bottom to top, with time increasing upward as indicated by the “TIME” label and arrow at the top.

The sequence begins with a single GPS message 802 connected to a basic track 804. As time progresses, subsequent GPS messages (806, 814, 818, etc.) arrive and generate increasingly complex tracks. Each track is represented by solid boxes indicating data containers that store vehicle information such as position, orientation (yaw), and velocity.

In some implementations, the system may generate tracks for multiple objects detected by the LiDAR sensors. The first LiDAR message 810 appears after several GPS messages and creates its own track 812 with associated data containers. The diagram shows alternating patterns of GPS and LiDAR messages.

As the tracking process continues, the system may employ a probabilistic matching algorithm to identify the ego vehicle among the detected objects. This matching process may involve calculating a matching error value, such as a Mahalanobis distance, between the GPS tracks and the LiDAR tracks for each potential match.

The Mahalanobis distance may be calculated using the following formula:

$$D = \sqrt{{( x - μ )}^{T} {S}^{- 1} ( x - μ )} ,$$

where D where D is the Mahalanobis distance, x is the vector of observed values (e.g., position, orientation, velocity from LiDAR data), μ is the vector of predicted values (e.g., position, orientation, velocity from GPS data), S is the covariance matrix that describes the uncertainties and correlations between variables, T denotes the transpose of a matrix, and −1 denotes the inverse of a matrix.

In some implementations, the system may use this Mahalanobis distance to compare tracks from different data sources. A smaller Mahalanobis distance may indicate a closer match between the predicted (GPS) and observed (LiDAR) states, helping to identify the most likely correspondence between the ego vehicle and detected objects.

In some implementations, the system may calculate a total confidence value for each potential match. This total confidence value may be based on a function of individual error values (comparing matched tracks directly) and relative error values (considering how well a potential match compares to other candidates). The total confidence value may be expressed as:

$$C [ {E}_{e g o} ] + α \cdot Δ E \times {objE}_{e g o} = Error ,$$

where C is the confidence, E_{ego} is the individual error for the ego vehicle, a is a weighting factor, ΔE is the change in error, and objE_{ego} is the relative error compared to other objects. This approach allows the system to adapt to changing environments and recover from temporary mismatches or occlusions. The ego vehicle object may be determined based on this total confidence value exceeding a predefined threshold (e.g., 0.9).

In some implementations, the system may handle special cases such as temporary LiDAR occlusions. If an object disappears from LiDAR detection for a short period, the system may continue to expand the tracking region around its last known position. This allows the system to quickly re-identify the object once it becomes visible again, without needing to restart the entire matching process.

The system may also address scenarios where multiple objects have similar error values. In cases where no previous most likely object has been identified, the system may form more tracks and choose the object with the maximum probability. When a previous most likely object exists, it may be given priority in the matching process.

In some implementations, if no object is found confidently within a certain timeframe (e.g., 2 seconds), the system may lower its confidence threshold (e.g., from 0.9 to 0.75) to identify the most likely object. This adaptive thresholding helps the system maintain tracking even in challenging conditions.

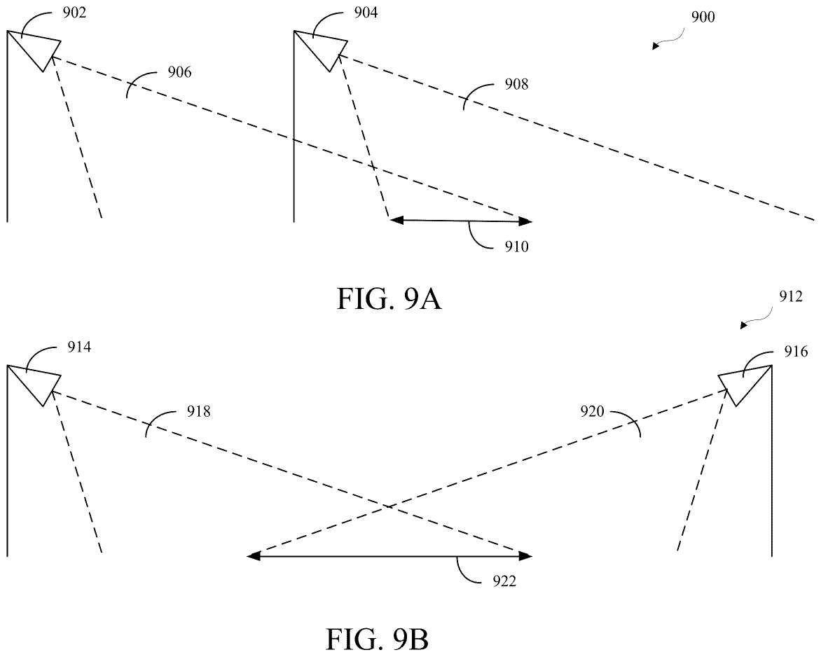

The track matching system may also incorporate techniques for handling transitions between different LiDAR sensors' coverage areas. As vehicles move through the environment, they may pass from the field of view of one sensor to another. The system may implement a handoff process to maintain continuous tracking during these transitions, as illustrated in FIGS. 9A and 9B.

The track matching process illustrated in FIGS. 6-8 provides a robust method for vehicle localization by fusing data from multiple sources, generating time-sequenced tracks, and employing probabilistic matching techniques. This approach enables the system to accurately identify and track an ego vehicle among multiple detected objects, even in challenging environments with varying sensor coverage and data quality.

In some implementations, a linear track-matching approach may be employed to identify an ego vehicle or object among multiple detected objects in lidar data. This approach may be considered practical and engineering-oriented, though it may exhibit less robustness. It may be relatively quick to develop and straightforward to debug and tune, and it may perform effectively for certain use cases. It may be implemented independently from any other track-matching approach, such that it could be included in a separate application. The overall problem statement for this approach, including time synchronization (i.e., “Time sync”), aligns with prior methods in that GPS data is used to synchronize lidar data.

During a first step (i.e., Step 1), GPS data may be acquired to achieve time synchronization, which enables alignment of the lidar data. If GPS data is available and a time sync has been established, the system may proceed with a second step (i.e., Step 2). In this second step, the system may identify the potential ego object among the detected objects by first locating the objects closest to the GPS-indicated position. For example, the system may identify the ten closest objects in terms of x-y distance, but if there are fewer than ten objects within a designated radius, it may limit the set to those objects actually within that radius. If only a single object is found within that radius, and that situation persists, the system may treat that object as the ego vehicle. However, in many instances, multiple objects are located within the relevant radius.

When no previous matches are available (i.e., the system has not yet identified an ego object in prior frames), the system may check whether any object among the ten closest objects is within half a car length and half a car width of the GPS position. If such an object is found, the system may designate that object as the likely ego. If no object is found under these constraints, the system may skip the frame, record any errors, and increase the relevant thresholds for subsequent checks.

If more than one object matches the position constraints, the system may use velocity (v) if that velocity exceeds a minimum threshold. It may compare the velocities of these closest objects, select the top five that most closely match the GPS-indicated velocity, and then evaluate whether at least one of those five objects is within a tight distance error tolerance and a tight velocity error tolerance. If no object meets those tighter constraints, the system may loosen the thresholds and record errors. If exactly one object meets the tighter constraints, it may be designated as the ego object. If more than one object meets these constraints, the system may compare yaw among these top five objects. Specifically, it may check for any object whose yaw error, velocity error, and distance error are each under a specified threshold. If none is found, the system may again loosen the thresholds and record errors. If exactly one object is identified, that object may be designated as ego. If more than one remains, the system may record an error, tighten thresholds, and re-check.

If the velocity is below the minimum threshold, the system may not rely on velocity matching first. Instead, it may evaluate yaw among the top ten closest objects and check for one whose yaw error and distance error are below certain thresholds. If no object satisfies these conditions, the system may loosen thresholds and record errors. If exactly one object satisfies these conditions, it may be selected as ego. If more than one object qualifies, the system may record an error, tighten thresholds, and reevaluate. In this manner, the system may linearly check each error metric in a univariate fashion and stop the search once a suitable match is identified. After the system identifies a likely ego object, it may record the object's identification (ID). If the same ID remains consistent for a certain number (N) of times, the system may confirm that object as the ego. The system may similarly switch from an incorrect ego if subsequent checks indicate a different match is more appropriate.

When a previous match is available (i.e., the system has identified an ego object in a prior frame), the system may first check a small radius around the previously matched object's location. If an object is found in that small radius and it has the same ID, the system may designate it as the ego. If it has a different ID, the system may reapply the checks described above, beginning with velocity-based checks if velocity is above the minimum threshold. Specifically, the velocity of all the closest objects may be evaluated, and the top five whose velocities most closely match the expected ego velocity may be examined for tight distance and velocity errors. If no object meets these tighter constraints, the system may loosen thresholds and note errors. The objects may be sorted by their respective errors and IDs, and higher-priority checks may be applied to objects with lower errors in the next cycle. If a single object passes all checks, that object may be selected as ego. If more than one object satisfies the constraints, yaw may be evaluated in a similar manner, checking for objects with yaw error, velocity error, and distance error below certain thresholds. If this again leads to no object, thresholds may be loosened, errors noted, and objects sorted by error. If multiple objects remain candidates, the system may record an error, tighten thresholds, and choose the object with the lowest error, or continue evaluating further frames if confidence remains low.

When the velocity is below the minimum threshold, the system may rely on yaw and distance errors. Among the top ten objects, yaw checks may be performed to determine whether any object meets defined yaw error and distance error thresholds. If none is found, the system may loosen thresholds, record errors, and sort objects by error. If exactly one object remains, that object may be selected as ego. If more than one remains, the system may note an error, tighten thresholds, and sort the objects by error. If decision-making remains inconclusive after sorting, the system may re-check in the next frame. If the same object continues to exhibit the lowest error across frames, the system may develop confidence that this object is the ego. If that does not occur, the system may reduce thresholds and continue searching.

If the system does not locate any object in the radius surrounding the previously identified ego object, this scenario may indicate that the original match was incorrect or that the object in question has disappeared. Fusion processes may address objects that have disappeared, while the linear track-matching approach described here may address potential misidentifications by expanding the search radius and repeating the above procedures. In doing so, the system may sort objects by error to converge on a different object than the previously matched one if the previously matched object was deemed incorrect. Additional iterations may be required to build confidence in the newly identified ego object, and the system may skip frames until confidence is established.

In summary, this linear approach may differ from other methods (e.g., those using tracklets and Mahalanobis distance) by employing a univariate error-checking process, examining potential matches in a stepwise manner, and stopping once a match satisfies the thresholds. In some implementations, this approach may be less robust than more sophisticated methods, it may be relatively quick to implement, debug, and tune, and it may effectively address certain practical engineering requirements.

FIGS. 9A and 9B are diagrams illustrating examples associated with infrastructure sensor handoff in a controlled roadway region, in accordance with the present disclosure. These figures depict different configurations of LiDAR sensor systems that may be implemented for vehicle tracking and localization.

FIG. 9A shows an example 900 of a LiDAR sensor configuration where two sensors are positioned along a route to monitor adjacent areas. In this configuration, LiDAR sensor 902 and LiDAR sensor 904 are arranged to create overlapping sensing regions. Sensing region 906, associated with LiDAR sensor 902, and sensing region 908, associated with LiDAR sensor 904, intersect to form a handoff zone 910. This arrangement may allow for continuous tracking of vehicles as they move between the coverage areas of different sensors.

In some implementations, the LiDAR sensors 902 and 904 may be mounted on existing infrastructure, such as street lights or traffic signals. In some implementations, they may be installed on dedicated poles or structures specifically designed for sensor placement. The height and positioning of these sensors may be optimized to provide the best coverage of the roadway while minimizing occlusions from other vehicles or obstacles.

The sensing regions 906 and 908 may be defined by the range and field of view of their respective LiDAR sensors. In some implementations, these regions may be dynamically adjusted based on factors such as traffic density, weather conditions, or specific tracking requirements. For example, the system may increase the power or adjust the scanning patterns of the LiDAR sensors to extend the sensing regions during periods of low traffic or to compensate for reduced visibility in adverse weather conditions.

The handoff zone 910 may play a role in maintaining continuous tracking of vehicles as they move between the coverage areas of different sensors. In some implementations, the size and shape of the handoff zone may be optimized to ensure smooth transitions between sensors. This may involve adjusting the overlap between sensing regions or implementing specialized algorithms for data fusion within the handoff zone.

In some implementations, the handoff operation in the scenario of FIG. 9A may involve a coordinated process between LiDAR sensor 902 and LiDAR sensor 904 to maintain continuous tracking of vehicles as they move through the handoff zone 910. As a vehicle approaches the edge of sensing region 906, the system may begin preparing for the handoff by increasing the frequency of data collection and processing for that specific vehicle. This preparation phase may allow for a more seamless transition between sensors and may reduce the likelihood of tracking errors during the handoff.

During the handoff process, both LiDAR sensor 902 and LiDAR sensor 904 may simultaneously track the vehicle within the handoff zone 910. In some aspects, the system may employ a weighted fusion algorithm that gradually shifts the importance of data from one sensor to the other as the vehicle moves through the handoff zone. This approach may help to smooth out any discrepancies between the two sensors' measurements and may provide a more consistent tracking experience. The weighting factors may be dynamically adjusted based on factors such as the vehicle's position within the handoff zone, the relative signal strengths of the sensors, and the estimated accuracy of each sensor's measurements.

After the vehicle has successfully transitioned into sensing region 908, the system may continue to monitor data from LiDAR sensor 902 for a short period to ensure tracking continuity. In some implementations, this post-handoff verification phase may involve comparing the trajectory predictions from both sensors to detect any potential tracking errors or inconsistencies. If a discrepancy is detected, the system may initiate a track recovery procedure, which may include temporarily expanding the tracking region or requesting additional data from nearby sensors to resolve the ambiguity. This multi-stage handoff process may help to ensure robust and reliable vehicle tracking across the entire controlled roadway region, even in challenging scenarios with high traffic density or adverse environmental conditions.

FIG. 9B illustrates an alternative configuration, shown as example 912, where LiDAR sensors are positioned facing each other. In this arrangement, LiDAR sensor 914 and LiDAR sensor 916 are placed on opposite sides of the roadway, creating sensing region 918 and sensing region 920, respectively. These sensing regions intersect to form a larger handoff zone 922 compared to the configuration shown in FIG. 9A.

The face-to-face configuration of LiDAR sensors 914 and 916 may offer several advantages in certain scenarios. In some implementations, this arrangement may provide better coverage of the roadway, particularly for multi-lane highways or wide intersections. The larger handoff zone 922 may allow for more robust tracking and smoother transitions between sensors, potentially improving the accuracy of vehicle localization in complex traffic scenarios.

In some implementations, the LiDAR sensors 914 and 916 may be equipped with adaptive scanning capabilities. This could allow the sensors to dynamically adjust their scanning patterns based on the current traffic conditions or specific tracking requirements. For example, the sensors might focus more attention on areas with higher vehicle density or adjust their resolution to better track smaller objects like pedestrians or cyclists.

The sensing regions 918 and 920 may be defined not only by the capabilities of the LiDAR sensors but also by software-defined parameters. In some implementations, the system may dynamically adjust the effective sensing regions based on factors such as the current tracking tasks, computational resources available, or the need for more detailed scans in certain areas. This flexibility may allow the system to optimize its performance in real-time, adapting to changing conditions within the controlled roadway region.

The handoff zone 922 in the face-to-face configuration may offer opportunities for data fusion and cross-validation. In some implementations, the system may use the overlapping data from both sensors to improve the accuracy of object detection and tracking. This could involve techniques such as multi-view point cloud registration or collaborative filtering algorithms that leverage the different perspectives provided by the two sensors.

In the scenario depicted in FIG. 9B, the handoff operation may involve a more complex process due to the face-to-face configuration of LiDAR sensor 914 and LiDAR sensor 916. As a vehicle approaches the handoff zone 922, both sensors may begin tracking the vehicle simultaneously, potentially providing a more comprehensive view of the vehicle's position and orientation. This dual-perspective tracking may allow for enhanced accuracy in vehicle localization, especially in scenarios with high traffic density or complex road geometries.

In some implementations, the system may employ a fusion algorithm that combines data from both LiDAR sensors 914 and 916 throughout the entire handoff zone 922, rather than gradually transitioning from one sensor to another as in the FIG. 9A scenario. This continuous fusion approach may provide a more stable and consistent tracking experience, as the system can leverage the strengths of both sensors' perspectives at all times. In some implementations, the system may assign different weights to the data from each sensor based on factors such as the vehicle's position within the handoff zone, the estimated accuracy of each sensor's measurements, and the current environmental conditions.

Unlike the handoff operation in FIG. 9A, where the vehicle transitions from one sensing region to another, the face-to-face configuration in FIG. 9B may allow for extended tracking within the larger handoff zone 922. This extended tracking period may provide additional opportunities for the system to refine its localization estimates and resolve any ambiguities. In some cases, the system may continue to track the vehicle using both sensors even after it has passed through the center of the handoff zone, potentially improving the robustness of the tracking process and reducing the likelihood of losing track of the vehicle during the transition.

In both configurations shown in FIGS. 9A and 9B, the LiDAR sensors may be supplemented with other types of sensors to create a more comprehensive sensing system. In some implementations, cameras, radar systems, or infrared sensors may be co-located with the LiDAR sensors to provide additional data for object classification and tracking. This multi-modal approach may enhance the system's ability to handle diverse environmental conditions and improve overall tracking reliability.

The choice between the configurations shown in FIGS. 9A and 9B, or other potential arrangements, may depend on various factors specific to the controlled roadway region. In some implementations, the system may employ a combination of these configurations, adapting the sensor layout to the specific geometry and requirements of different road sections. For example, the face-to-face configuration might be preferred for wide intersections, while the adjacent sensor arrangement might be more suitable for long stretches of straight roadway.

In some implementations, the LiDAR sensors shown in FIGS. 9A and 9B may be part of a larger network of sensors distributed throughout the controlled roadway region. This network may include sensors with varying capabilities and ranges, allowing the system to balance between wide-area coverage and detailed, high-resolution scanning in certain areas. The data from all these sensors may be integrated within a central processing system, which may employ advanced algorithms for sensor fusion, object tracking, and vehicle identification.

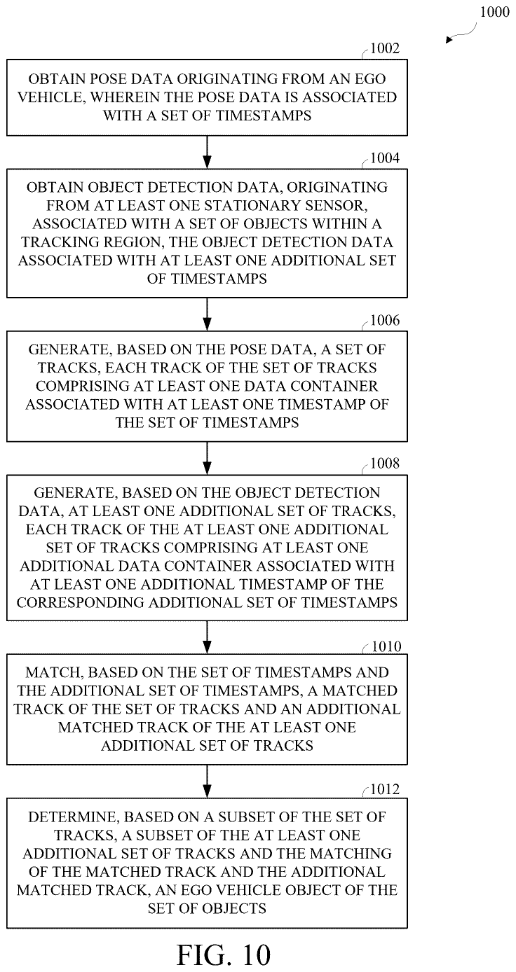

To further describe some implementations in greater detail, reference is next made to examples of techniques which may be performed by or using the vehicle localization system as described herein. FIG. 10 is a flowchart of an example of a technique associated with track matching for vehicle localization. The technique 1000 can be executed using computing devices, such as the systems, hardware, and software described with respect to FIGS. 1-9. The technique 1000 can be performed, for example, by executing a machine-readable program or other computer-executable instructions, such as routines, instructions, programs, or other code. The steps, or operations, of the technique 1000, or another technique, method, process, or algorithm described in connection with the implementations disclosed herein can be implemented directly in hardware, firmware, software executed by hardware, circuitry, or a combination thereof.

For simplicity of explanation, the technique 1000 is depicted and described herein as a series of steps or operations. However, the steps or operations of the technique 1000 can occur in various orders and/or concurrently. Additionally, other steps or operations not presented and described herein may be used. Furthermore, not all illustrated steps or operations may be required to implement a technique in accordance with the disclosed subject matter.

At 1002, the technique 1000 includes obtaining pose data originating from an ego vehicle, wherein the pose data is associated with a set of timestamps. For example, a vehicle identification component (e.g., the vehicle identification component 510 shown in FIG. 5) may receive pose data from a GPS device installed in the ego vehicle. In some implementations, the pose data may comprise a set of geographic positions, a set of orientation measurements, and a set of velocity measurements, each geographic position corresponding to an orientation measurement of the set of orientation measurements, a velocity measurement of the set of velocity measurements, and a timestamp of the set of timestamps.

At 1004, the technique 1000 includes obtaining object detection data, originating from at least one stationary sensor, associated with a set of objects within a tracking region, the object detection data associated with at least one additional set of timestamps. In some implementations, this step may involve receiving data from infrastructure components (e.g., the infrastructure components 408 shown in FIG. 4) such as LiDAR sensors positioned along the roadway. The object detection data may include additional sets of orientation measurements and velocity measurements corresponding to the additional set of timestamps for each detected object within the tracking region.

At 1006, the technique 1000 includes generating, based on the pose data, a set of tracks, each track of the set of tracks comprising at least one data container associated with at least one timestamp of the set of timestamps. For example, the vehicle identification component may create a series of data containers, each containing a geographic position, an orientation measurement, and a velocity measurement from the pose data, organized by timestamp. In some implementations, the set of tracks may include a first track associated with a first timestamp and a second track associated with a second timestamp, where the second track includes data containers from both the first and second timestamps.

At 1008, the technique 1000 includes generating, based on the object detection data, at least one additional set of tracks, each track of the at least one additional set of tracks comprising at least one additional data container associated with at least one additional timestamp of the corresponding additional set of timestamps. This step may involve creating similar data container structures for each detected object, based on the LiDAR or other sensor data. In some implementations, each additional data container may include an orientation measurement and a velocity measurement for the corresponding object at a specific timestamp.

At 1010, the technique 1000 includes matching, based on the set of timestamps and the additional set of timestamps, a matched track of the set of tracks and an additional matched track of the at least one additional set of tracks. This step may involve comparing the tracks generated from the ego vehicle's pose data with the tracks generated from the object detection data to identify potential matches. In some implementations, the matching process may use techniques such as temporal alignment and spatial proximity to identify corresponding tracks.

At 1012, the technique 1000 includes determining, based on a subset of the set of tracks, a subset of the at least one additional set of tracks and the matching of the matched track and the additional matched track, an ego vehicle object of the set of objects. This step aims to identify which of the detected objects corresponds to the ego vehicle. In some implementations, this determination may be based on calculating a matching error value, such as a Mahalanobis distance value, between the matched tracks. The ego vehicle object may be determined based on the matching error value satisfying certain criteria or thresholds.

In some implementations, the technique 1000 may include additional steps to improve the accuracy and robustness of the ego vehicle identification process. For example, the system may determine a quantity of matched tracks and use this information in the ego vehicle object determination. If the quantity of matched tracks satisfies a predefined threshold, it may increase the confidence in the identification.

The technique 1000 may also include steps for managing the computational resources required for track matching. In some implementations, the system may determine that a quantity of tracks in the set of tracks satisfies a quantity threshold and, based on this determination, delete older tracks to maintain a manageable number of tracks for processing. This approach helps balance the need for historical data with the constraints of real-time processing.

To adapt to varying environmental conditions and object densities, the technique 1000 may include steps for dynamically adjusting the tracking region. In some implementations, if the count of objects in the set of objects is less than or equal to a first object threshold, the system may obtain additional object detection data from an expanded tracking region. Conversely, if the number of objects exceeds a certain threshold, the system may establish a smaller tracking region to focus on the most relevant objects.

In some implementations, the technique 1000 may incorporate probabilistic methods to handle uncertainties in both the pose data and object detection data. For example, the ego vehicle object determination may be based on a multivariate probability value associated with the comparison between the matched track and the additional matched track. This probability value may need to satisfy a predefined threshold for the object to be considered the ego vehicle.

Furthermore, the technique 1000 may utilize a total confidence value in determining the ego vehicle object. This total confidence value may be based on a function of a set of error values and a set of relative error values. By considering both absolute and relative errors, the system can adapt to different scenarios and maintain robust performance even in challenging conditions.

The foregoing disclosure provides illustration and description but is not intended to be exhaustive or to limit the aspects to the precise forms disclosed. Modifications and variations may be made in light of the above disclosure or may be acquired from practice of the aspects. As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, the terminology “instructions” may include directions or expressions for performing any technique, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, techniques, or combinations thereof, as described herein. Instructions, or a portion thereof, may be implemented as a special purpose processor, or circuitry, that may include specialized hardware for carrying out any of the techniques, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the terminology “or” is intended to mean an inclusive “or” rather than an exclusive “or” and may be used interchangeably with “and/or,” unless explicitly stated otherwise (for example, if used in combination with “either” or “only one of”), or clearly is used otherwise from context. In addition, the articles “a” and “an” as used in this application and the appended claims should generally be construed to mean “one or more” unless specified otherwise or clear from context to be directed to a singular form. Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Accordingly, unless explicitly stated otherwise, the phrase “based on” is intended to mean “based at least in part on.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. Further, for simplicity of explanation, although the figures and descriptions herein may include sequences or series of steps or stages, elements of the techniques disclosed herein may occur in various orders or concurrently. Additionally, elements of the techniques disclosed herein may occur with other elements not explicitly presented and described herein. Furthermore, not all elements of the techniques described herein may be required to implement a technique in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method, comprising:
obtaining pose data originating from an ego vehicle, wherein the pose data is associated with a set of timestamps;
obtaining object detection data, originating from at least one stationary sensor, associated with a set of objects within a tracking region, the object detection data associated with at least one additional set of timestamps;
generating, based on the pose data, a set of tracks, each track of the set of tracks comprising at least one data container associated with at least one timestamp of the set of timestamps;
generating, based on the object detection data, at least one additional set of tracks, each track of the at least one additional set of tracks comprising at least one additional data container associated with at least one additional timestamp of the corresponding additional set of timestamps;
matching, based on the set of timestamps and the additional set of timestamps, a matched track of the set of tracks and an additional matched track of the at least one additional set of tracks; and
determining, based on a subset of the set of tracks, a subset of the at least one additional set of tracks and the matching of the matched track and the additional matched track, an ego vehicle object of the set of objects.

2. The method of claim 1, the pose data comprising a set of geographic positions, a set of orientation measurements and a set of velocity measurements, each geographic position corresponding to an orientation measurement of the set of orientation measurements, a velocity measurement of the set of velocity measurements, and a timestamp of the set of timestamps.

3. The method of claim 2, wherein each data container of the set of tracks comprises a geographic position of the set of geographic positions, an orientation measurement of the set of orientation measurements, and a velocity measurement of the set of velocity measurements.

4. The method of claim 2, the object detection data comprising at least one additional set of orientation measurements corresponding to the at least one additional set of timestamps and at least one additional set of velocity measurements corresponding to the at least one additional set of timestamps, the at least one additional set of orientation measurements comprising, for an object of the set of objects and a corresponding additional set of timestamps of the at least one additional set of timestamps, a corresponding additional set of orientation measurements and a corresponding additional set of velocity measurements.

5. The method of claim 4, wherein each data container of the at least one additional data container comprises an additional orientation measurement of the additional set of orientation measurements, and an additional velocity measurement of the at least one additional velocity measurements.

6. The method of claim 1, wherein the set of tracks comprises:
a first track associated with a first timestamp of the set of timestamps, the first track comprising a first data container of the at least one data container; and
a second track associated with a second timestamp of the set of timestamps, the second track comprising the first data container and a second data container of the at least one data container.

7. The method of claim 6, wherein the matched track comprises the second track.

8. The method of claim 7, wherein the additional matched track comprises a first additional track of the at least one additional set of tracks, and wherein determining the ego vehicle object comprises:
determining, based on a comparison of the matched track and the additional matched track, a matching error value; and
determining, based on the matching error value, the ego vehicle object.

9. The method of claim 8, wherein the matching error value comprises a Mahalanobis distance value.

10. The method of claim 1, further comprising:
determining a quantity of matched tracks, wherein determining the ego vehicle object comprises determining the ego vehicle object based on the quantity of matched tracks satisfying a quantity threshold.

11. The method of claim 1, further comprising:
determining that a quantity of tracks of the set of tracks satisfies a quantity threshold; and
deleting, based on the quantity of tracks satisfying the quantity threshold, a first track of the set of tracks.

12. The method of claim 1, further comprising:
determining that a count of objects in the set of objects is less than or equal to a first object threshold; and
obtaining, based on the determining that the count of objects in the set of objects is less than or equal to the first object threshold, additional object detection data originating from at least one stationary sensor, associated with an additional set of objects within an additional tracking region.

13. The method of claim 11, wherein determining the ego vehicle object comprises determining the ego vehicle object based on the set of objects and the set of additional objects.

14. A system, comprising:
one or more memories; and
processing circuitry configured to execute instructions stored in the one or more memories to cause the system to:
obtain pose data originating from an ego vehicle, wherein the pose data is associated with a set of timestamps;
obtain object detection data, originating from at least one stationary sensor, associated with a set of objects within a tracking region, the object detection data associated with at least one additional set of timestamps;
generate, based on the pose data, a set of tracks, each track of the set of tracks comprising at least one data container associated with at least one timestamp of the set of timestamps;
generate, based on the object detection data, at least one additional set of tracks, each track of the at least one additional set of tracks comprising at least one additional data container associated with at least one additional timestamp of the corresponding additional set of timestamps;
match, based on the set of timestamps and the additional set of timestamps, a matched track of the set of tracks and an additional matched track of the at least one additional set of tracks; and
determine, based on a subset of the set of tracks, a subset of the at least one additional set of tracks and the matching of the matched track and the additional matched track, an ego vehicle object of the set of objects.

15. The system of claim 14, wherein the processing circuitry is configured to execute the instructions to further cause the system to:
obtain additional object detection data, originating from at least one stationary sensor, associated with an additional set of objects within an additional tracking region, the additional tracking region having a size larger than the tracking region;
determine that a count of objects in the additional set of objects is greater than an object threshold; and
establish the tracking region based on the determining that the count of objects in the additional set of objects is greater than the object threshold.

16. The system of claim 14, wherein the pose data comprises a set of geolocation data originating from a global positioning system device of the ego vehicle, and wherein the at least one stationary sensor comprises a light detection and ranging device.

17. A non-transitory medium having embodied thereon computer-executable instructions that, when executed by processing circuitry, cause the processing circuitry to perform operations, the operations comprising:
obtaining pose data originating from an ego vehicle, wherein the pose data is associated with a set of timestamps;
obtaining object detection data, originating from at least one stationary sensor, associated with a set of objects within a tracking region, the object detection data associated with at least one additional set of timestamps;
generating, based on the pose data, a set of tracks, each track of the set of tracks comprising at least one data container associated with at least one timestamp of the set of timestamps;
generating, based on the object detection data, at least one additional set of tracks, each track of the at least one additional set of tracks comprising at least one additional data container associated with at least one additional timestamp of the corresponding additional set of timestamps;
matching, based on the set of timestamps and the additional set of timestamps, a matched track of the set of tracks and an additional matched track of the at least one additional set of tracks; and
determining, based on a subset of the set of tracks, a subset of the at least one additional set of tracks and the matching of the matched track and the additional matched track, an ego vehicle object of the set of objects.

18. The non-transitory medium of claim 17, wherein the pose data comprises a set of geolocation data originating from a global positioning system device of the ego vehicle, and wherein the at least one stationary sensor comprises a light detection and ranging device.

19. The non-transitory medium of claim 17, wherein determining the ego vehicle object comprises determining the ego vehicle object based a multivariate probability value associated with a comparison between the matched track and the additional matched track satisfying a probability threshold.

20. The non-transitory medium of claim 17, wherein determining the ego vehicle object comprises determining the ego vehicle object based on a total confidence value, wherein the total confidence value is based on a function of a set of error values and a set of relative error values.
